(19) United States
(12) Patent Application Publication
(10) Pub. No.: US 2019/0110140 A1
(43) Pub. Date: Apr. 11, 2019

(54) Body-Worn Personal Device with Pairing Control

(71) Applicant: Sonova AG, Staefa (CH)

(72) Inventors: Georg Dickmann, Ebmatingen (CH); Andreas Breitenmoser, Zürich (CH)

(73) Assignee: Sonova AG, Staefa (CH)

(21) Appl. No.: 16/086,614

(22) PCT Filed: Apr. 7, 2016
(86) PCT No.: PCT/EP2016/057560

§ 371 Date: Sep. 20, 2018

(51) Int. Cl. H04R 25/00

(52) U.S. Cl. CPC H04R 25/554; H04R 25/558; H04R 2225/61; H04R 2225/55; H04R 25/552

(57) ABSTRACT

There is provided a personal device to be worn at the body of a user, comprising: an interface (20) for wireless data exchange with an external device (11, 39); at least one sensor (28, 42, 44, 46) for sensing a parameter indicative of the proximity of the personal device to the user; a use detection unit (40) for determining, by regularly analyzing signals received from the sensor(s), whether the personal device is presently worn by the user or not; and a control unit (38) for controlling operation of the personal device in a pairing disable mode as long as the use detection unit determines that the personal device is worn by the user and in a pairing enable mode as long as the use detection unit determines that the personal device is not worn by the user, wherein in the pairing disable mode the requirements for acceptance, by the personal device, of a pairing request received from an external device via the interface are more strict than in the pairing enable mode.

The invention relates to a personal device to be worn at the body of a user, such as a hearing assistance device; which may be a hearing aid, comprising an interface for wireless data exchange with an external device.

Body worn devices, in particular hearing aids, may have a very small and limited user interface (due to size constraints), which may result in problems in wireless pairing processes of such devices. Security risks of such pairing processes involving devices with a minimal user interface may be due to two main factors. First, if no dedicated user control exists which can be used to cause the personal device to become pairable, some existing user gesture is likely to be “overloaded” to enter a pairable state; for example, some devices become pairable for a pre-configured time period after power-on of the device (i.e. in this case the “overloaded” user gesture is the operation of a power-on control, such as a button, by the user). Second, devices with limited user interface may not be able to present or take-in authentication information that a user could deal with before a pairing request received by the personal device is accepted. Therefore, pairing requests are typically accepted unconditionally as long as the device is in a pairable state (see, for example, the Bluetooth “just-works” pairing mechanism).

However, in setups wherein the device automatically enters a pairable state, either periodically or as a result of a user action/gesture that is not specific to the entering of the pairable state (such as turning-on of the device), an external device that is not supposed to pair with the personal device could manage to become paired and thus exercise undesired control over the personal device. This is most relevant in situations where the personal device is used in public, so that other devices or persons could track down an opportunity to impose a pairing on the personal device; this applies in particular to personal devices which use a “just-works” pairing policy wherein, due to lack of a rich user interface, no credentials need to be entered in order to authenticate an external device requesting to become paired.

US 2015/0163585 A1 relates to a method of pairing a smartphone with a hearing aid, wherein “out-of-band” communication, such as a picture of the hearing aid taken by the smartphone, is used to establish pairable state and to identify a given hearing aid among other hearing aids; to this end, the smartphone may also read a barcode or QR code provided on a storage container of the hearing aid; also the distance between the hearing aid and the smartphone may be taken into account.

U.S. Pat. No. 8,554,140 B2 relates to a method of pairing wireless audio devices, such as media players, with hearing assistance devices, wherein pairing may be controlled/restricted by restricting the pairing range by reducing the transmission power accordingly and by restricting the time period during which pairing is allowed; further, pairing may be restricted to trusted devices which are identified by a device ID, such as an MAC address.

U.S. Pat. No. 8,472,874 B1 relates to a method of pairing mobile audio devices, wherein pairing may be restricted by the requirement of physical proximity, the requirement of the presence of a specific third device or the requirement of exchange of cryptographic keys.

It is an object of the invention to provide for a personal device with a wireless interface which is configured to allow for pairing with external devices in a manner which is convenient to the user but nevertheless provides at least for some protection with regard to unwanted pairing. It is a further object to provide for a corresponding pairing method.

According to the invention, these objects are achieved by a personal device as defined in claim 1 and a method as defined in claim 25, respectively.

The invention is beneficial in that, by sensing whether the personal device is presently worn by the user or not and by applying a relatively stricter pairing policy during times when the personal device is found to be worn by the user, relatively convenient pairing is possible during times when the personal device is not worn by the user, while security risks which typically primarily occur during times when the personal device is worn by the user, such as in public, may be avoided by rendering pairing more restricted in such situations.

Preferred embodiments are defined in the dependent claims.

Hereinafter, examples of the invention will be illustrated by reference to the attached drawing which is a schematic block diagram of an example of a personal device according to the invention when used together with other wireless devices.

The sole FIGURE is a block diagram of an example of a system comprising a personal device wirelessly interacting with other devices, wherein the personal device may be a first hearing assistance device 10 to be worn at one ear of a user, while the interacting devices may be a second hearing assistance device 11 to be worn at the other ear of the user and at least one remote device 39. The first and second hearing assistance devices 10, 11 typically are ear level devices and preferably form a binaural hearing system. Preferably, the hearing devices 10, 11 are hearing instruments, such as BTE (behind-the-ear), ITE (in-the-ear) or CIC (completely-in-the-canal) hearing aids. However, the hearing devices, for example, also could be an auditory prosthesis, such as a cochlear implant device comprising an externally worn sound processor.

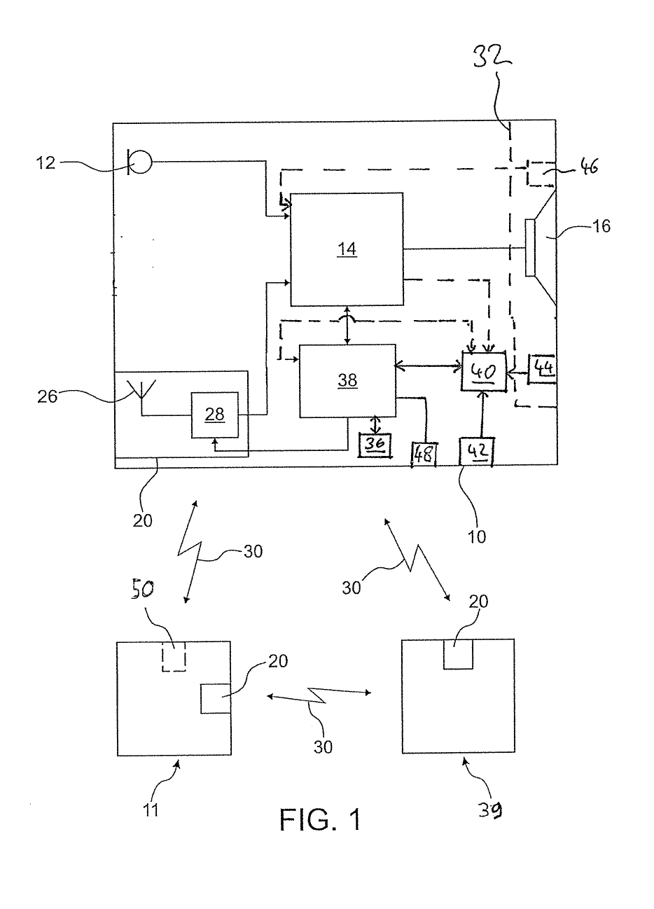

In the example of FIG. 1, the hearing assistance devices 10, 11 are hearing aids comprising a microphone arrangement 12 for capturing audio signals from ambient sound, an audio signal processing unit 14 for processing the captured audio signals and an electro-acoustic output transducer (loudspeaker) 16 for stimulation of the user's hearing according to the processed audio signals (these elements are shown in FIG. 1 only for the hearing aid 10).

The hearing aids 10, 11 comprise a wireless interface 20 comprising an antenna 26 and a transceiver 28.

The interface 20 is provided for enabling wireless data exchange between the first hearing aid 10 and the second hearing aid 11 via a wireless link 30 which serves to realize a binaural hearing assistance system, allowing the hearing aids 10, 11 to exchange audio signals and/or control data and status data, such as the present settings of the hearing aids 10, 11.

The interface 20 is also provided for data exchange via a wireless link 30 from or to an external device 40, for example for receiving an audio data stream from an external device 40 acting as an audio source, comprising a wireless interface 20.

For example, the interface 20 may be adapted to operate in a frequency range of 0.38 GHz to 5.825 GHz, preferably at frequencies around 2.4 GHz in the ISM band. Typically, the interface 20 is a Bluetooth interface, such as a Bluetooth Smart or a Bluetooth Smart Ready interface; alternatively, it may use another standard protocol, or it may be a proprietary interface.

The hearing aids 10, 11 also comprise a controller 38 for controlling operation of the hearing aids 10, 11, with the controller 38 acting on the signal processing unit 14 and the transceiver 28, and a memory 36 for storing data required for operation of the hearing aid 10, 11 and data required for operation of the interface 20, such as pairing/network data.

The hearing device 10 further comprises at least one sensor for sensing a parameter indicative of the proximity (or distance) of the device 10 to the user and a use detection unit 40 for determining, by regularly analyzing signals received from such sensor (s), whether the hearing device 10 is presently worn by the user or not. The use detection unit 40 provides a corresponding input to the controller 38 which thereby is enabled to control operation of the hearing device 10 in a pairing disable mode as long as the use detection unit 40 determines that the hearing device 10 is worn by the user and in a pairing enable mode as long as the use detection unit 40 determines that the hearing device 10 is not worn by the user.

In the pairing disable mode the requirements for acceptance, by the personal device (e.g. the hearing device 10), of a pairing request received from an external device (such as the other hearing device 11 or the remote device 39) via the wireless interface 20 are more strict than in the pairing enable mode.

According to the example shown in FIG. 1, the hearing device 20 may comprise a first use detection sensor 42 and a second use detection sensor 44, which may comprise, for example, an accelerometer, an orientation sensor, a temperature sensor or a humidity sensor.

An accelerometer may be used for sensing movement of the hearing device 10, and the use detection unit 40 may decide, for example, that the device 10 is not worn by the user if the sensed acceleration is below a given threshold value for at least a given time interval (for example, if the hearing device 10 has been placed on a table, it will no longer move).

A temperature sensor is particularly useful if placed in close proximity to the body; preferably, a temperature sensor 44 may form part of an earpiece (indicated at 32 in FIG. 1) so as to be situated in the ear canal of the user. For example, the temperature sensor may be integrated within the loudspeaker/receiver 16 of the hearing device 10 (in case that the hearing device 10 is of the ITE or RIC type). The use detection unit 40 may decide that the device 10 is worn by the user if the sensed temperature is within a given temperature range around the typical body temperature of 37° C. or is in the process of converging towards 37° C. (for example, in case where the device 10 has just been inserted in the canal).

Also in case that the sensor is a humidity sensor, it should be placed in close proximity to the body; in particular it may be placed in the ear canal as part of an earpiece 32. The use detection unit 40 may decide that the device 10 is worn by the user if the sensed humidity is above a given threshold (humidity is high in the ear channel).

According to another example, the use sensors may comprise an acoustic feedback sensor in order to measure an acoustic feedback path of the hearing device 10; for example, such feedback sensor may comprise an (auxiliary) microphone 46 located in the ear channel (typically as part of an earpiece 32, such as in case of a RIC type hearing device). The feedback detection may be realized as part of the audio signal processing unit 14 which receives the signal of the auxiliary microphone 46; the audio signal processing unit 14 may supply a corresponding output to the use detection unit 40 indicative of the detected feedback. The use detection unit 40 may decide that the device 10 is worn by the user if the sensed feedback is above a given threshold value, or, more generally, if the audio signals deviate sufficiently from a feedback pattern known for worn devices (acoustic feedback typically is not scalar value), i.e. that feedback is present.

According to another example, the use sensors may comprise an electromagnetic signal strength sensor (in the hearing device of the FIGURE the transceiver 28 may serve as such sensor), wherein the use detection unit 40 may decide that the device 10 is worn by the user if the strength of a signal received from another wireless device worn by the user is above a given threshold. For example, such other wireless device may be the other hearing device 11 of a binaural system, i.e. the hearing device worn at the other ear of the user; in this case the use detection unit 40 may decide that the device 10 is worn by the user if the strength of the signal received from the other hearing device is above a given lower threshold below a given upper threshold (indicating that the distance between the devices corresponds to a typical ear-to-ear distance). According to another example, the wireless device to be worn by the user may be an accessory device of the hearing device 10, such as a wireless microphone, a remote control and/or a streaming device, or it may be a personal communication device of the user, such as a smartphone (for example, the remote device 39 shown in FIG. 1 may be such accessory device or personal communication device). Loss of contact with such other wireless device usually worn by the user indicates that the hearing device 10 is not worn by the user. The received signal strength may be detected by the wireless interface 20 itself.

Preferably, the use detection unit 40 uses a plurality of the above described sensor options in order to achieve high reliability of a judgement whether the device is presently worn by the user or not.

According to another example, the use sensors may comprise an orientation sensor for determining the orientation of the device, in particular with regard to the direction of gravity, wherein the use detection unit 40 may decide that the device 10 is worn by the user if the sensed orientation of the device 10 does not differ by more than a certain degree from a predefined use orientation, i.e. from the orientation the device 10 usually has when it is worn at the ear of the user. Another criterion may be whether the orientations sensed by the orientation sensors of the two hearing devices of a binaural system differ or are substantially the same; differing orientations are an indicator that the binaural system presently is not worn (in the FIGURE, the orientation sensor of the hearing device 11 is indicated at 50).

Device 10 operates in a pairing disable mode as long as the use detection unit 40 determines that the device is worn by the user and in a pairing enable mode as long as the use detection unit 40 determines that the device 10 is not worn by the user, wherein in the pairing disable mode the requirements for acceptance, by the device 10, of a pairing request received from an external device such as the device 11 or the remote device 39, via the interface 20 are more strict than in the pairing enable mode.

According to one example, in the pairing disable mode pairing may be generally prohibited unless at least one of a plurality of override conditions is fulfilled. Examples of such override conditions may be: (1) the personal device has never been paired yet (i.e. it is in an “out of the box” state); (2) an explicit pairing instruction is received by the personal device from a trusted device (i.e. a device which is trusted more than the device requesting to become paired); (3) a specific pre-defined pairing enable gesture has been performed on a user interface of the personal device; (4) the personal device receives an out-of-band acoustic, electromagnetic or optical signal (i.e. a signal which is not transmitted via the wireless link 30) from the external device which is recognized by the device 10 as a trusted signal.

For example, the trusted device of example (2) may be a pairing manager device which comprises a user interface for inputting authentication information, such as a PIN.

The pairing enable gesture of example (3) may comprise a pre-defined voice signal captured by the microphone 12 and/or a predefined pressing sequence on a button of a user interface 48 of the device 10.

The out-of-band signal of example (4) may be transmitted by the external device seeking to pair with the device 10 along with the pairing request. According to an alternative example, the out-of-band signal may be transmitted by the external device upon having received an out-of-band confirmation request transmitted by the device 10 to the external device in response to having received a pairing request from the external device. In any case, pairing is allowed by the device 10 only in case that the correct (i.e. the expected) out-of-band signal is received. In general, by using out-of-band signals for confirming a pairing request, restrictions like the need for a calm environment, proximity or line-of-sight positioning can be imposed on the pairing process.

According to one embodiment, pairing in the pairing disable mode upon fulfillment of at least one of the override conditions may be allowed only if in addition a predetermined spatial proximity requirement, i.e. a minimum distance, between the device 10 and the external device wishing to pair with the device 10 is found to be fulfilled; such proximity requirement may be monitored by analyzing the strength of the wireless signal received by the device 10 from the external device so as to enhance security against unwanted pairing.

Another example for an override condition applies to a binaural system comprising, in addition to the hearing device 10 to be worn at one of the ears, a hearing device 11 to be worn at the other ear. According to this example, the strength of a signal received by the device 10 from the other hearing device 11 is analyzed and, if the signal strength is found to be above a given threshold value which is higher than the signal strength expected when the hearing devices 10, 11 are worn at the respective ears, pairing is allowed by the device 10 (while this criterion could be used to allow pairing of another hearing device only, it also could be used to allow pairing with other external devices). This condition actually implements an override condition specifically for pairing with the other hearing device of a binaural system, including a specific proximity criterion, namely that the (second) hearing device 11 is closer to the (first) hearing device 10 than it would be during normal use (wherein the distance between the two hearing devices 10, 11 corresponds to the distance between the ears). The reason for implementing this proximity criterion is that during normal use of a binaural system pairing typically should be inhibited, with the presence of a second hearing device 11 at the expected ear-to-ear distance indicating that the hearing device 10 is worn by the user, whereas pairing with a second hearing device 11 in principle should be possible in order to establish a binaural system. An additional criterion could be the timing of a pairing gesture performed on both hearing devices of a binaural system: if the pairing gesture is performed at different times on both hearing devices, the hearing devices may inhibit pairing, but if the pairing gesture is performed on both hearing devices at the same time within a given tolerance time period, pairing may be allowed. This, again, may apply to both pairing of hearing devices to each other and to pairing with external devices.

According to one example, in the pairing enable mode the requirements for pairing may be very low. For example, in the extreme case, each pairing request may be accepted by the device 10 in the pairing enable mode. According to a more restrictive example, in the pairing enable mode each pairing request may be accepted when received within a given time period after power-on of the device 10, i.e. after power-on of the device there is a certain time window during which pairing is particularly easy and unrestricted.

According to one example, the external device seeking to pair with the device 10 may, in case that the conditions for pairing are presently not met (for example, because the use detection unit 40 determines the device 10 to be worn by the user and none of the override conditions is found to be fulfilled), guide the user of the device 10 on how to establish the conditions required for pairing. This requires that the external device seeking to pair with the device 10 comprises a suitable user interface. For example, the external device may include a display or a loudspeaker for providing optical or acoustic information to the user as to what he should do with the device 10 in order to enable pairing. For example, the external device may instruct the user to take the device 10 off the ear in order to cause the device 10 to enter the pairing enable mode. According to another example, the external device may instruct the user to perform the specific pre-defined pairing enable gesture mentioned above in example (3) of the override conditions.

1. A device, the device comprising:
an interface for wireless data exchange with an external device;
a sensor for sensing a parameter indicative of proximity of the device to a user;
a use detection unit for determining, by analyzing signals received from the sensor, whether the device is presently worn by the user;
a control unit for controlling operation of the device in a pairing disable mode as long as the use detection unit determines that the personal is worn by the user and in a pairing enable mode as long as the use detection unit determines that the device is not worn by the user,
wherein in the pairing disable mode the requirements for acceptance, by the device, of a pairing request received from an external device via the interface are more strict than in the pairing enable mode.

2. The device of claim 1, wherein in the pairing disable mode pairing is prohibited unless at least one of the following override conditions is fulfilled:
the device has never been paired yet;
an explicit pairing instruction is received by the device from a trusted device;
a pre-defined pairing enable gesture has been performed on a user interface of the device;
the device receives an out-of-band acoustic, electromagnetic or optical signal from the external device which is recognized by the device as a trusted signal; or
the is a first ear-level hearing assistance device to be worn at a first ear of the user and the external device is a second ear-level hearing assistance device to be worn at a second ear of the user for forming a binaural system together with the first hearing assistance device, wherein the sensor comprises an electromagnetic signal strength sensor, and wherein the strength of a signal from the second ear-level hearing assistance device is above a given threshold higher than the signal strength expected when the first and second hearing assistance devices are worn at the first and second ear, respectively.

3. The device of claim 2, wherein the pre-defined pairing enable gesture comprises at least one of a pre-defined voice signal captured by a microphone of the device and a pre-defined pressing sequence on a button of the device.

4. The device of claim 3, wherein the trusted device is a pairing manager device comprising a user interface for inputting authentication information, such as a Personal Identification Number (PIN).

5. The device of one of claim 4, wherein the out-of-band signal is transmitted by the external device together with the pairing request.

6. The device of claim 4, wherein the out-of-band signal is transmitted by the external device upon having received an out-of-band confirmation request transmitted by the device to the external device in response to a pairing request from the external device.

7. The device of claim 6, wherein the control unit is configured to allow pairing in the pairing disable mode upon fulfilment of at least one of the override conditions only if a predetermined spatial proximity requirement between the device and the external device is found to be fulfilled.

8-11. (canceled)

12. The device of claim 1, wherein the device is to be worn at ear level.

13. The device of claim 12, wherein the device is a hearing aid.

14. The device of claim 1, wherein the sensor comprises at least one of an accelerometer, an orientation sensor, a temperature sensor, a humidity sensor, an acoustic feedback sensor, or an electromagnetic signal strength sensor.

15. The device of claim 1, wherein the sensor comprises an accelerometer, and wherein the use detection unit is configured to decide that the device is not worn if a sensed acceleration is below a threshold value for a time interval.

16. The device of claim 15, wherein the sensor comprises a temperature sensor, and wherein the use detection unit is configured to decide that the device is worn if a sensed temperature is inside a temperature range.

17. The device of claim 1, wherein the sensor comprises a humidity sensor, and wherein the use detection unit is configured to decide that the device is worn if a sensed humidity is above a threshold.

18. The device of claim 1, wherein the sensor comprises an acoustic feedback sensor, and wherein the use detection unit (40) is configured to decide that the device is worn by the user if the sensed feedback is above a given threshold.

19. The device of claim 18, wherein the sensor comprises an electromagnetic signal strength sensor, and wherein the use detection unit is configured to decide that the device is worn by the user if the strength of a signal from a wireless device to be worn by the user is above a given threshold.

20-24. (canceled)

25. A method for controlling pairing of a device, the method comprising:
sensing a parameter indicative of proximity of the device to a user;
determining whether the device is presently worn by the user based on the sensed parameter; and
controlling operation of the device in a pairing disable mode as long as the device is worn by the user and controlling operation of the device in a pairing enable mode as long as the device is not worn by the user.

26. The method of claim 25, the method further comprising:
detecting that a pairing request sent from an external device to the device has not been confirmed;
providing information to the user for guiding the user of the device on how to handle the device so as to establish conditions required for pairing of the device with the external device.

27. The method of claim 25, wherein sensing is based on a temperature sensor.

28. The method of claim 25, wherein sensing is based on an accelerometer.

29. A non-transitory computer-readable medium storing instructions that when executed by a processor cause a device to perform operations, the operation comprising:
sensing a parameter indicative of proximity of a device to a user;
determining whether the device is presently worn by the user based on the sensed parameter; and
controlling operation of the device in a pairing disable mode when the device is worn by the user; and
controlling operation of the device in a pairing enable mode when the device is not worn by the user.
